(19) United States
(12) Patent Application Publication
(10) Pub. No.: US 2025/0343725 A1
(43) Pub. Date: Nov. 6, 2025

(54) SYSTEM AND METHOD FOR MANAGING OUTAGES IN A NETWORK

(71) Applicant: Badawi Yamine, Beirut (LB)

(72) Inventor: Badawi Yamine, Beirut (LB)

(21) Appl. No.: 18/817,114

(22) Filed: Aug. 27, 2024

(30) Foreign Application Priority Data
May 1, 2024 (IN) 202411034688

(51) Int. Cl. H04L 41/0654; H04L 41/14

(52) U.S. Cl. CPC H04L 41/0654; H04L 41/145

(57) ABSTRACT

The present disclosure relates to a system (100) for managing outages in a network, the system (100) includes a network management component (104) operatively coupled to one or more base stations (102) and a computing device (108). The network management component (104) having an OSS unit (106) configured to generate and transmit an alarm during outage to the computing device (108), and perform calculations to analyze a set of attributes pertaining to total duration of outage of each base station (102), weight of each base station (102), expected duration to repair each base station (102), predictions and planned outages of the one or more base stations (102) and any combination thereof and integrate decision-making process for dispatching one or more technicians, potential drone deployment, and outage period communication to associated mobile devices, while prioritizing recovery of the one or more base stations based on calculated set of attributes.

### TECHNICAL FIELD

The present disclosure relates to the field of wireless telecommunications. More precisely, the present disclosure relates to a system and a method for the selection of base stations according to priority for recovery during outages.

### BACKGROUND

An equipment failure in a mobile wireless network can occur unexpectedly due to software or hardware issues, or it can be anticipated and planned by the operator. Planned failures may result from scheduled network activities, such as software or hardware upgrades. For instance, software upgrades are periodically performed to introduce new features or resolve bugs, while hardware upgrades involve implementing newer equipment versions with enhanced capabilities. Such upgrades aim to improve network performance, capacity, and efficiency.

However, the existing systems suffer from limitations including the lack of a systematic approach for prioritizing the recovery of sites during network outages, inefficiency in decision-making during network outages, and the absence of a tool capable of accurately estimating maintenance times for technicians to resolve equipment failures.

Firstly, the problem associated with the lack of a systematic approach for prioritizing the recovery of sites during network outages is disclosed. Existing methods fail to consider various criteria when deciding which site a technician should attend to first. For instance, at 01:35 am, technician 1, located at Z, received an outage notification for gNB1 and began travelling towards it, which is 1 hour away. At 01:45 am, gNB2, located 10 minutes away from Z, also experienced an outage. By this time, technician 1 had travelled approximately 10 minutes towards gNB1, reaching location Z1. Faced with two outages, technician 1 could both continue to gNB1 first and then address gNB2 (Scenario 1), or prioritize gNB2 before returning to gNB1 (Scenario 2). Without a systematic approach, technicians may make suboptimal decisions, leading to prolonged network downtime and potential revenue loss for the operator. In another instance, in a scenario where one site experiences a higher volume of call requests compared to another, prioritizing the recovery of the latter site may be more beneficial despite both sites experiencing the same duration of outage. Consequently, the absence of a comprehensive decision-making framework based on multiple criteria poses a significant challenge for operators in efficiently managing network outages and minimizing service disruptions.

The inefficiency in decision-making during network outages is addressed, where the output of planned outage activities and predictive tools is not considered. Despite the availability of advanced artificial intelligence (AI) and machine learning (ML) prediction tools in wireless networks, decisions regarding technician dispatch are not informed by these outputs. For instance, when a site experiences an outage and a technician is dispatched, the decision does not account for predicted outages or planned activities affecting nearby sites. In a scenario, at 11:40 pm, technician 1 responds to an outage at gNB10, located an hour away from their position at Z. Unaware of a predicted outage at gNB11, 30 minutes away from Z in the opposite direction of gNB10 and serving a critical area, technician 1 proceeds to gNB10. Upon learning of the impending outage at gNB11 at midnight, technician 1 redirects their route, incurring a 20-minute delay to return to Z before heading to gNB11. In the existing system, the technicians may prioritize recovery based solely on the current outage, leading to suboptimal resource allocation and potential delays. Integrating the output of predictive tools and planned outage activities into decision-making processes could enhance response efficiency and minimize downtime.

The absence of a tool capable of accurately estimating maintenance times for technicians to resolve equipment failures is another identified problem, considering factors such as technician expertise and site accessibility. This deficiency results in two primary issues: inefficient resource allocation, as decisions on dispatching resources, like drones carrying radio nodes, rely solely on travel time without accounting for repair durations. For instance, if a nearby technician requires 30 minutes to reach the site, and 40 minutes to replace the radio unit (RU), and if by chance the drone needs also 30 minutes to reach that site, the decision of not sending a drone, by ignoring the technician's repair time, could result in prolonged downtime, 40 minutes, for example, for critical services such as mobile network technology e.g., 5G coverage in the affected area.

Inaccurate communication with subscribers is another consequence, where outage durations may be miscommunicated due to reliance on generalized repair estimates, potentially leading to dissatisfaction and loss of trust. Certain applications such as holograms function exclusively on 5G and forthcoming 6G networks, not on 2G, 3G, 4G, or Wi-Fi. Subscribers in areas like areal of gNB21, impacted by a 5G or 6G site outage, would benefit from knowing the expected duration of the outage. However, without an accurate tool for estimating repair times for each site, operators cannot communicate precise outage durations. For instance, while an estimated 10-minute outage may be typical for most sites, the actual outage at gNB21 could be 40 minutes, highlighting the need for precise outage communication tools.

Therefore, it is desired to overcome the drawbacks, shortcomings, and limitations associated with existing solutions, and develop a system that facilitates onsite technicians in determining the optimal site for recovery during outages, prioritizing based on weight and conducting simulated calculations to assess cost-effectiveness. It incorporates predictive outage analysis, enhances outage duration estimation accuracy, and improves decision-making for deploying resources like drones, benefiting both traditional and open Radio Access Network (RAN) networks.

### Objects of Disclosure

An object of the present disclosure is to provide a system that enables onsite technicians to determine the optimal site for recovery among two sites of equal priority.

Another object of the present disclosure is to provide a system that allows technicians to prioritize site recovery during outages based on weight.

Another object of the present disclosure is to provide a system that conducts simulated calculations of total outage durations for two sites under two scenarios: one technician recovering both sites, and two technicians recovering each site individually. This serves as a tool for operators to assess the cost-effectiveness of deploying additional technicians during simultaneous outages

Another object of the present disclosure is to provide a system that considers the outcome of scheduled outages and predictions for subsequent outages before dispatching technicians to recover sites experiencing current outages.

Another object of the present disclosure is to provide a system for estimating the duration required for an onsite technician to recover faulty equipment at a specific site (gNBi), denoted as T_repair_gNBi, with enhanced accuracy compared to existing methods. This feature calculates T_repair_gNBi from the moment the technician departs their location to the site until they leave after recovery, incorporating various factors such as travel time, equipment type, site access permissions, antenna height, and technician skill levels.

Another object of the present disclosure is to provide a system that enhances decision-making efficiency regarding deploying drones carrying radio nodes to sites experiencing outages by accurately estimating the duration required for an onsite technician to recover faulty equipment at a specific site, T_repair_gNBi.

Another object of the present disclosure is to provide a system that communicates accurate outage duration estimates, including time of travel of the technician to reach the site in addition to T_repair_gNBi, to affected subscribers.

Yet another object of the present disclosure is to provide a system that addresses common issues and implements proposed methods applicable to both traditional networks and open RAN networks.

### SUMMARY

The present disclosure relates to a system and a method for the selection of base stations according to priority for recovery during outages. The main objective of the present disclosure is to overcome the drawbacks, limitations, and shortcomings of the existing system and solution, by providing a method and system for outage management in a network environment, wherein a software entity implemented at the network side performs calculations at a designated time (t2) to simulate total outage durations for two sites (site 1 and site 2) based on different recovery scenarios. The scenarios involve a technician's sequential recovery of the sites, considering factors such as distance from the technician, estimated repair duration for each site, the outcome of scheduled outages and predictions for subsequent outages and the respective weight of each site. The objective is to advise the technician on the preferred scenario by comparing simulated outage durations and selecting the scenario resulting in minimal operator damage. Additionally, the method facilitates accurate estimation of outage periods for individual sites, aiding decisions for deploying resources like drone stations and informing subscribers potentially affected by the outage.

In an aspect of the present disclosure, the system for outage management in a network environment comprises a network management component operatively coupled to base stations and the computing device, the network management component having an OSS unit that is configured to generate an alarm signal indicating the outages of base stations, the outages pertain to network outages, equipment failures and any combination thereof. Transmit the alarm signal to the computing device associated with the one or more technicians located in the vicinity of corresponding base stations. Receive notifications, from the computing device, about the duration of time allocated to the corresponding base stations for recovery operation. Perform calculations to analyze a set of attributes influencing the recovery operation of the base stations. The set of attributes pertains to total duration of outage of each base station, weight of each base station, expected duration to repair each base station, predictions and planned outages and any combination thereof and integrates the decision-making process for dispatching one or more technicians, potential drone deployment, and outage period communication to associated mobile devices, while prioritizing the recovery of the one or more base stations based on the calculated set of attributes to facilitate resolving the outages.

Various objects, features, aspects, and advantages of the inventive subject matter will become apparent from the following detailed description of preferred embodiments, along with the accompanying drawing figures in which like numerals represent like components.

### BRIEF DESCRIPTION OF DRAWINGS

The specifications of the present disclosure are accompanied with drawings of the system and method to aid in better understanding of the said disclosure. The drawings are in no way limitations of the present disclosure, rather are meant to illustrate the ideal embodiments of said disclosure.

FIG. 1A illustrates an exemplary view of two sites within a designated area, in accordance with an embodiment of the present disclosure.

FIG. 1B illustrates an exemplary view of a system for managing outages, in accordance with an embodiment of the present disclosure.

FIG. 2A illustrates a flowchart depicting a method for prioritizing recovery based on the least total duration of outage for sites of equal weight, in accordance with an embodiment.

FIG. 2B illustrates a flow chart of a method for determining priority for technician deployment based on site weight discrepancies, in accordance with an embodiment.

FIG. 2C illustrates a flow chart of a method of comparing the cost of the total duration of outage with one technician in the field to the cost of the total duration of outage when more than one technician is in the field, in accordance with an embodiment.

FIG. 2D illustrates a flow chart of a method for integrating output from outage prediction tools and scheduled outages, in accordance with an embodiment.

FIG. 2E illustrates a flow chart of a method for calculating the duration for fixing an issue, in accordance with an embodiment.

FIG. 2F illustrates a flowchart depicting a method for determining the deployment of a drone to a specific site, in accordance with an embodiment.

FIG. 2G illustrates a flowchart depicting a method for communicating the outage period to subscribers, in accordance with an embodiment.

FIG. 3 illustrates a flowchart of an exemplary method for managing outages, in accordance with an embodiment of the present disclosure.

### DETAILED DESCRIPTION

The following is a detailed description of embodiments of the disclosure depicted in the accompanying drawings. The embodiments are in such details as to clearly communicate the disclosure. However, the amount of detail offered is not intended to limit the anticipated variations of embodiments. On the contrary, the intention is to cover all modifications, equivalents, and alternatives falling within the spirit and scope of the present disclosure as defined by the appended claims.

The term “site” refers to a geographical location where various equipment used in a mobile wireless network is installed. This includes radio base stations such as Base Transceiver Station (BTS), Node B (NB), evolved Node B (eNB), and Next-Generation Node (gNB), as well as other network components like transmission equipment, core network equipment (e.g., Mobility Management Entity (MME), Serving Gateway (SGW), Access and Mobility Management Function (AMF), User Plane Function (UPF), cloud equipment (e.g., servers hosting radio site software applications), antennas, and remote radio units.

The sites can encompass a wide range of equipment types and functions within a mobile wireless network. The terms “site,” “radio node,” “BTS,” “NB,” “eNB,” and “gNB” may be used interchangeably to denote the same concept. Similarly, the terms “mobile wireless network” and “network” are used synonymously to refer to the entire infrastructure supporting wireless communication services. It should be noted that even if the examples of description in-the present disclosure are related to mobile wireless communication in particular to 2G, 3G, 4G, 5G and coming 6G, the same problems and solutions are valid on any other type of wireless network, e.g. Wi-Fi, Lora and others. Furthermore, the same problems and solutions apply to equipment and machines that are not necessary part of a wireless equipment but belong to other types of network where the equipment and machines could be connected among them via wired, or wireless, communication, e.g. equipment and machines in a large factory, e.g. a car factory or a station that generates electricity and so forth.

The term “equipment” encompasses both hardware components (e.g., radio units, fans, antennas) and software entities (e.g., cells, applications running on network cloud). This inclusive definition allows for a comprehensive discussion of issues and solutions relevant to all aspects of mobile wireless network operations.

The present disclosure described herein for selecting and prioritizing site recovery in the event of equipment failure in a wireless network, applicable to various wireless technologies and equipment types, aims to optimize operator damage mitigation. Upon equipment failure, autonomous tools such as Self-healing and Self-Organizing Network (SON) are activated to mitigate subscriber impact. If initial reset attempts fail, technician dispatch or alternative coverage measures are considered. Criteria for technician decision-making, such as proximity, impact area coverage, and resource availability, are disclosed to ensure optimal recovery sequencing, thus minimizing operational disruptions.

A digital unit (DU) within a radio node site, configured as a hardware card or converted into an application running on a central server in a cloud environment, serves multiple functions, including processing radio algorithms, storing node configurations, establishing network connections, transmitting alarms to an Operations Support System (OSS) unit, and collecting performance counters for reporting. Additionally, the radio node comprises power supply components and cooling fans to support electronic card operation.

Furthermore, a radio unit (RU) with specified transmitting power capacity, connected to the DU via fiber optic cable and to antennas via coaxial cable, facilitates signal conversion, from analogue to digital and vice versa, and amplification for wireless communication.

In a wireless network, user equipment (UE) receiving radio coverage or being served by a cell engages in signaling and data exchange over the air interface.

The term “cell” refers to a software entity comprising hardware and software components of the Digital Unit (DU) and the Radio Unit (RU), along with antennas and interconnecting cables. Failure of any component within the cell, such as RU, DU, antennas, or cables, results in cell dysfunction and subsequent loss of radio coverage in the cell's area.

Typically, in each cell, one radio unit (RU) is linked to an antenna, implying that a RU failure results in cell outage. However, multiple RUs may be employed for increased power output in certain scenarios. Additionally, in the present disclosure, when referring to a site being in outage, it denotes one or more cells at that site experiencing downtime.

Each site, regardless of its Radio Access Technology (RAT), such as eNB or eNB, is configured with three cells. Each cell consists of a Digital Unit (DU), denoted as DU1, connected to three distinct Radio Units (RUs). Each RU is linked to an antenna covering 120 degrees of the surrounding area. Consequently, Cell 1 comprises DU1, RU1, and Antenna 1, covering 120 degrees, with corresponding interconnecting cables. Similarly, Cell 2 consists of DU1, RU2, and Antenna 2, while Cell 3 comprises DU1, RU3, and Antenna 3, each covering a 120-degree segment of the 360-degree space surrounding the site, along with respective interconnecting cables. The present disclosure can be described in enabling detail in the following examples, which may represent more than one embodiment of the present disclosure.

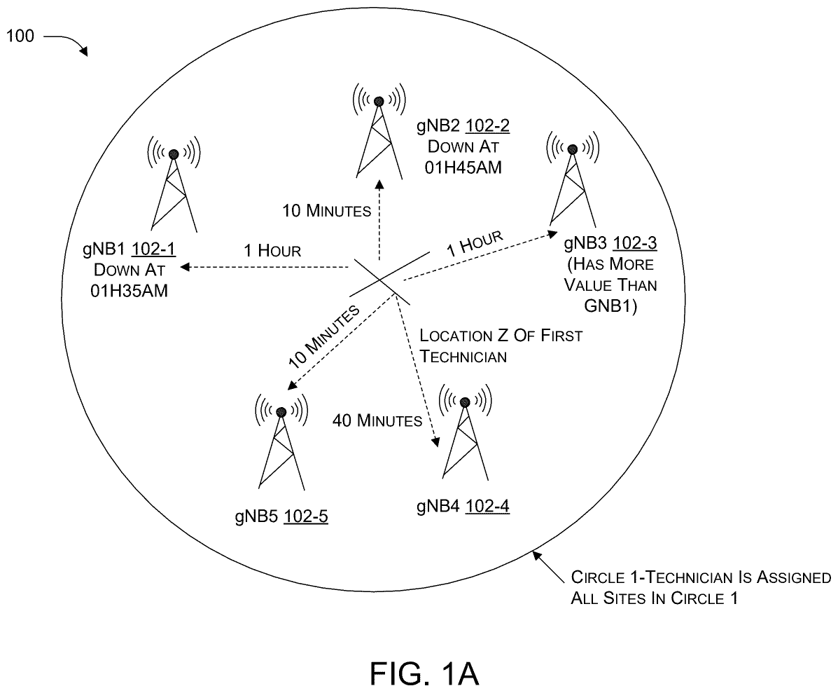

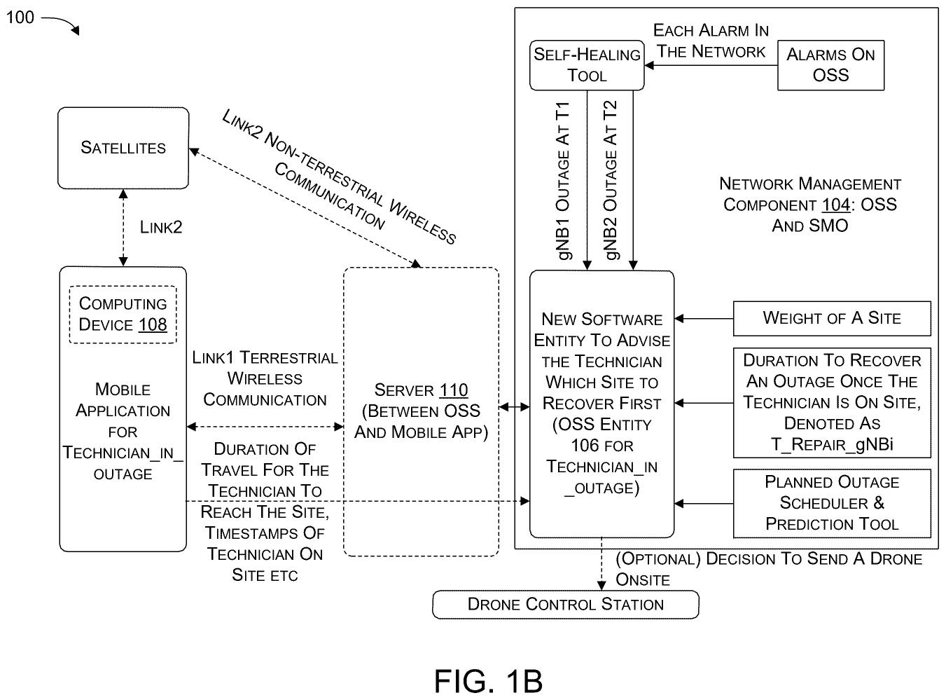

FIG. 1A illustrates an exemplary view of two sites within a designated area, in accordance with an embodiment of the present disclosure. The technician responsible for managing all outages within a designated area, such as circle1, may handle the outages at two sites, namely base stations (102-1 to 102-5 (which are individually referred to as base station 102 and collectively referred to as base stations 102, herein)). The base stations 102 can include a first base station (gNB1) and a second base station (gNB2).

FIG. 1B illustrates an exemplary view of a system for managing outages, in accordance with an embodiment of the present disclosure. Referring to FIG. 1B, system 100 for managing outages can include network management component 104 operatively coupled to one or more base stations 102 depicted in FIG. 1A. The network management component 104 encompasses both an operations support system (OSS) and a service management and orchestration (SMO). The network management component 104 can include OSS unit 106 designated as OSS_entity_for_technician_in_outage that is a software component intended for implementation, preferably within the OSS for traditional networks or at the SMO for open RAN networks. Alternatively, it may be deployed on a separate server, provided that the server maintains connectivity with the OSS and SMO to access inputs such as alarms and site parameters, as depicted in FIG. 1B. The mobile application residing in a computing device 108 associated with the technician, referred to as mobile_app_for_technician_in_outage is disclosed. The server 110 is configured to facilitate communications between the OSS unit 106 and the computing device 108.

The network management component 104 is operatively coupled to one or more base stations 102 and the computing device 108. The network management component 104 actually generates an alarm signal indicating the outages of one or more base stations 102, the outages pertain to network outages, equipment failures and any combination thereof. The OSS unit 106 transmits the alarm signal to the computing device 108 associated with the one or more technicians (also referred to as technicians, herein) who are located in the vicinity of the corresponding base stations 102. The technicians receive notifications, from the computing device, wherein the duration of time is allocated to the corresponding base stations 102 for the recovery operation.

The OSS unit 106 accesses various software units at the network management component 104, the software units configured to provide a self-healing tool, provide the total duration for an onsite technician to recover an outage on the corresponding base stations 102 for each type of faulty equipment, with consideration to presence of the one or more technicians at the respective base stations 102, provide the weights of each base station 102 and provide outcomes of a planned outage tool and an outages prediction tool. The OSS unit 106 is operatively coupled to a server that accesses a drone station and the computing device associated with the technicians through any or a combination of terrestrial wireless communication and non-terrestrial wireless communication.

In an exemplary embodiment, OSS unit 106 serves to communicate notifications of site outages to technicians or drone stations and performs calculations related to outage events, such as determining the total duration of outage for a specific site. The OSS unit 106 receives information related to outages of corresponding base stations 102 e.g. gNB1 has gone in outage or not, weights of the corresponding base stations 102 e.g., e.g. number of calls in a base station 102 during the period of outage, expected duration (T_repair_gNBi) required for an onsite technician to recover faulty equipment at a specific site (gNBi), and advance notifications of impending outages received through planned outage schedulers and prediction tools e.g., at time t1, regarding potential site outages, for example, gNB2, anticipated to occur at a later time, t2.

The OSS unit 106 is configured to generate notifications, whether concerning new outages or the results of calculations performed by the OSS unit 106. These notifications are primarily communicated to the computing device 108 associated with the technician responsible for site recovery or to a drone station if drone deployment is necessary, either with or without an accompanying technician onsite.

The communication of information from the OSS unit 106 to the onsite technician may occur through two options illustrated in FIG. 1B, firstly, via terrestrial wireless communication, such as through a 5G network (link1), or indirectly; and secondly, via satellite communication (link2), which proves beneficial when the onsite technician is situated in an area lacking terrestrial radio coverage due to the onsite outage.

The computing device 108 associated with the technician is required to install a set of instructions on the computing device 108 e.g., mobile phone, specifically designed for site outage management. The set of instructions serves two purposes: firstly, it receives notifications regarding site outages from the OSS unit 106 and secondly, it allows the technician to transmit information back to the network, particularly to the OSS unit 106, regarding site outages, such as the duration spent by the technician on a site for recovery purposes and time of travel for the technician to reach the site, e.g. based on a Global Positioning System (GPS) that is part of the computing device 108. The communication between the OSS unit 106 and the computing device 108 can occur directly or optionally via a third entity, such as server 110. In some instances, a third-party server may handle notifications and calculations of outage durations, with the OSS unit 106 providing input, such as site weights, to the server 110.

The OSS unit 106 is capable of performing calculations, such as determining the total duration of outages for sites of equal or differing weights. To conduct these calculations, it relies on input from the computing device 108, which provides information such as the duration of technician travel to sites experiencing outages. Conversely, the computing device 108 can also execute calculations, such as determining outage durations, with assistance from the OSS unit 106. In this scenario, the weight of each site must be transmitted from the OSS unit 106 to the computing device 108, as this information is solely accessible from the network management 104, which is accessible by the OSS unit 106. Therefore, the calculations pertaining to outages outlined in the present disclosure may be executed at either side, with support from the other side, facilitating flexibility in their performance and accessibility of pertinent data.

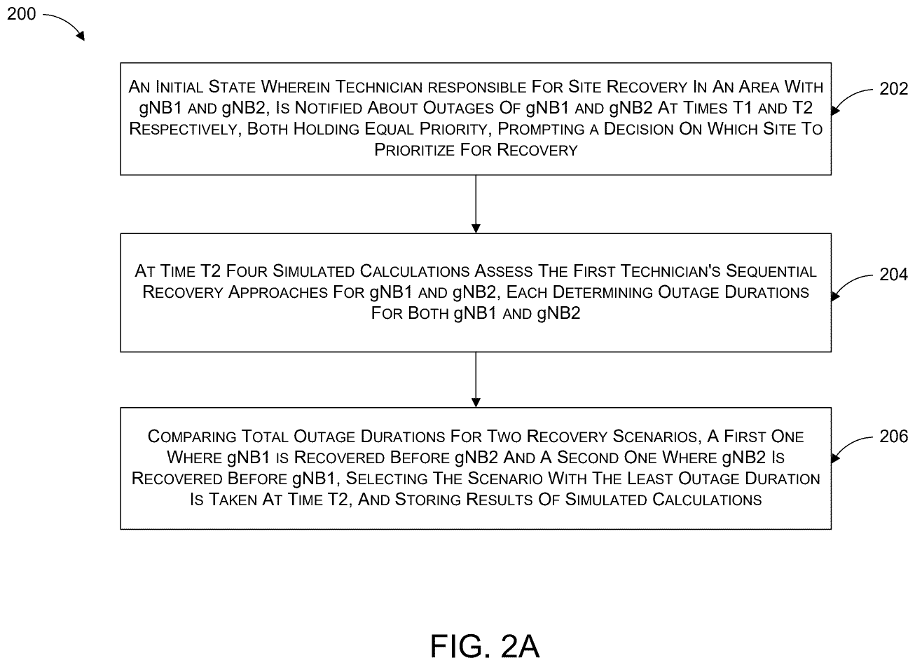

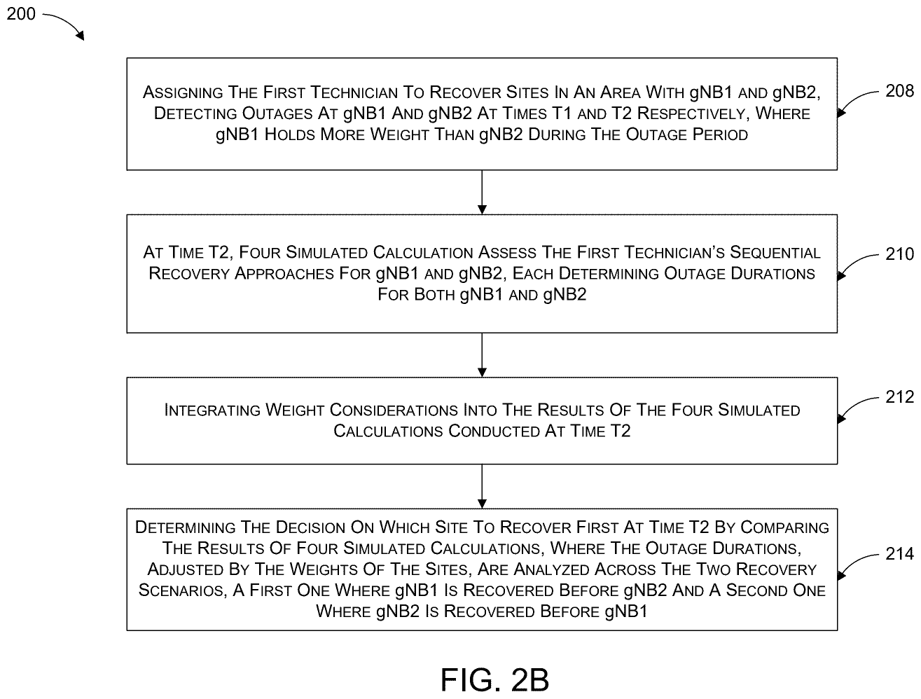

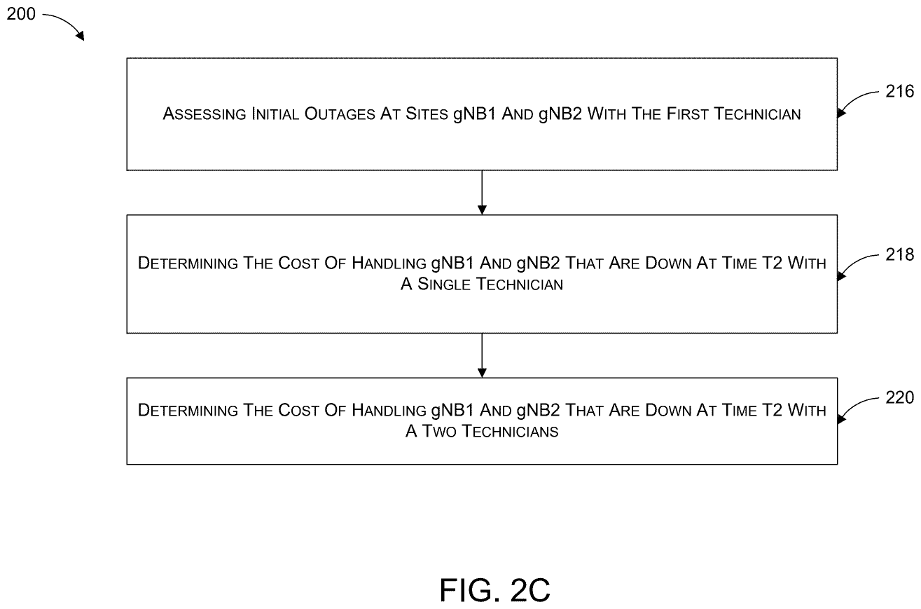

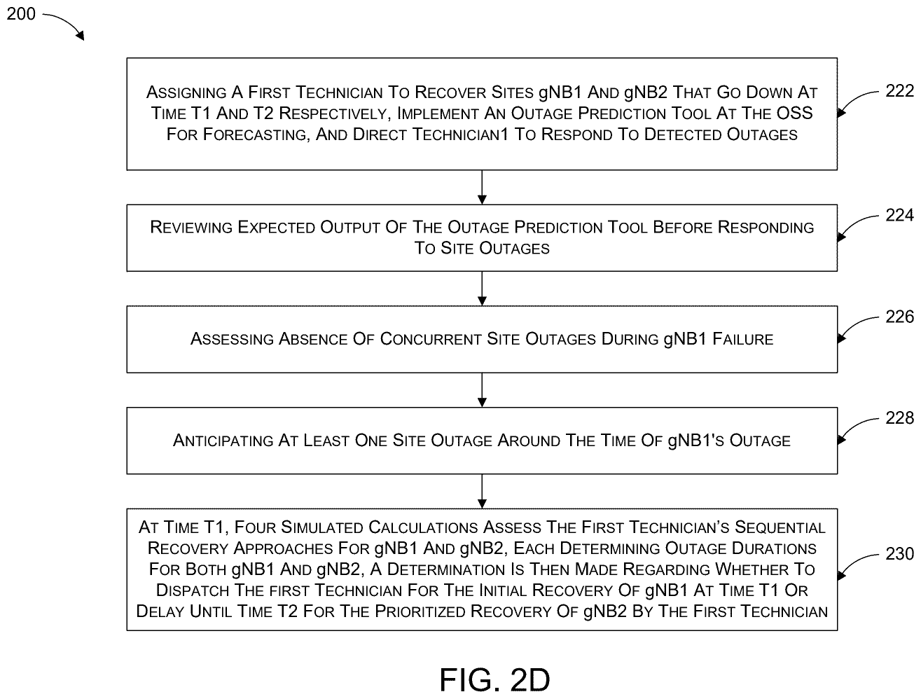

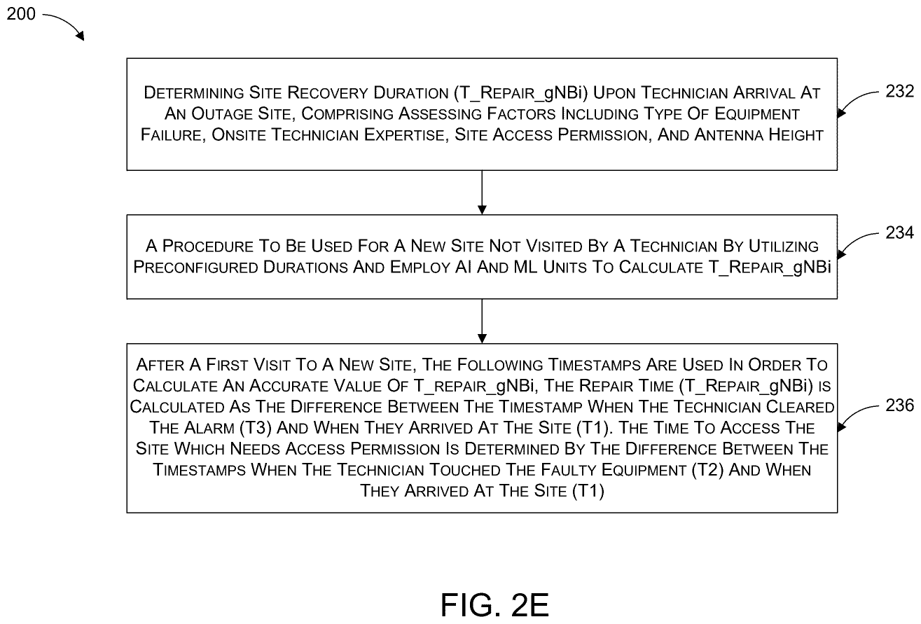

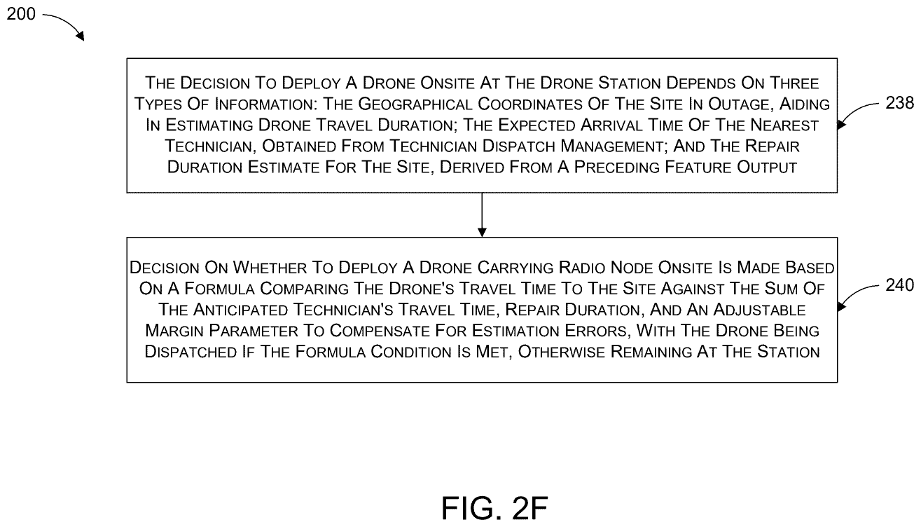

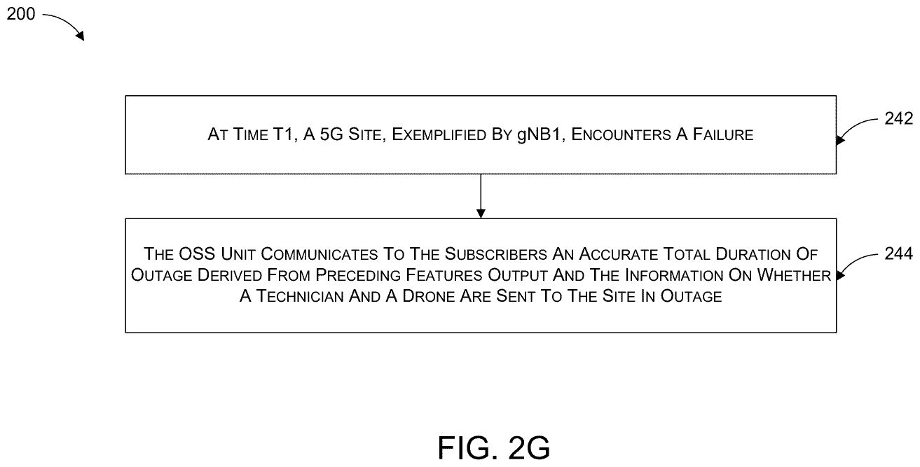

Certain outage calculations can be conducted independently by either the OSS unit 106 or the computing device 108 without reliance on information from the other side. For instance, the duration spent by an onsite technician to repair a site can be fully calculated by the technician himself. This can be achieved by the technician manually inputting timestamps of each action performed, such as the time of arrival at the site, accessing the equipment, and resolving the issue, directly into the computing device 108. The system 100 for efficient site outage management in networks can include the following set of attributes depicted FIG. 2A to 2G respectively and explained in detail below.
Priority for recovery based on the least total duration of outage for sites of equal weight.
Priority for recovery based on operator damage for sites of different weights.
Cost comparison between the total duration of an outage with a single technician versus multiple technicians in the field.
Consideration of output from outage prediction tools and planned outages.
Implementation of software entities to calculate the duration for issue resolution.
Decision-making process for drone deployment onsite.
Communication of outage periods to subscribers.

### Priority for Recovery Based on the Least Total Duration of Outage for Sites of Equal Weight.

In an embodiment, the OSS unit 106 is configured to manage the outages of the base stations 102 of equal weight experiencing outages at different times t1 and t2, respectively. Calculate outage durations under different recovery strategies, wherein the different recovery strategies include a first strategy that recovers a first base station 102 before a second base station 102 and a second strategy that recovers the second base station 102 before the first station. Consider distances and repair durations of the corresponding base stations 102, compare the total outage durations for each strategy to determine a strategy with least total outage duration to instruct the technicians of the strategy to follow and provide detailed information to the technicians regarding the repair duration required for each base station 102.

### Priority for Recovery Based on Operator Damage for Sites of Different Weights.

In another embodiment, the OSS unit 106 is configured to manage the outages of the one or more base stations 102 of different weights experiencing outages at different times t1 and t2, respectively. Perform calculations at time t2 to simulate the total duration of the outages for each base stations 102 in different strategies including a first strategy that recovers the first base station 102 before the second base station 102 and a second strategy that recovers the second base station 102 before the first station. Consider the distance of the corresponding base stations 102 from the vicinity of the one or more technicians, expected duration to repair each base station 102, and the weights of each base station 102. Compare sums of the outage durations multiplied by the weights of corresponding base stations 102 for each strategy. Select the strategy that results in less damage to the network and instruct the technicians on the optimal strategy.

The OSS unit 106 is configured to determine the weights of each base station 102 by analyzing different categories including historical call performance, number of Radio Access Technologies (RAT) deployed, cell size, coverage area type, and any combination thereof; and compare the weights of the different categories to prioritize the corresponding base stations 102 such as prioritize a first base station 102 covering a medical facility over a second base station 102 densely populated urban area despite lower call volume.

Cost comparison between the total duration of an outage with a single technician versus multiple technicians in the field.

In another embodiment, OSS unit 106 is configured to perform two types of simulated calculations at time t2 when two base stations 102, with equal or different weights, go into the outage at times t1 and t2 respectively, wherein the two types of simulated calculations include a first simulation that calculates the total outage duration of each base station 102 under two recovery scenarios, selecting the scenario resulting in the least total outage duration on both base stations 102. A second simulation assumes the presence of two technicians onsite and calculates the sum of the outage durations for each base station 102 when each technician is assigned to recover the corresponding base stations 102. Perform comparison between the least total outage duration from the first calculation and the sum of outage durations from the second calculation, conducted regularly, providing justification for employing a second technician based on network outage severity.

Consideration of Output from Outage Prediction Tools and Planned Outages.

In another embodiment, the OSS unit 106 is configured to consult the planned outage and the outage prediction tools upon occurrence of the outage at time t1 for the base stations 102. Determine the absence of predicted outages in the near term. Dispatch corresponding technicians onsite if a lack of expected outages is predicted. Delay the dispatch of the corresponding technicians until time t2 in case expected outages are predicted and receive the notification at time t2 indicating the prioritized base station 102 for recovery.

### Implementation of Software Entities to Calculate the Duration for Issue Resolution.

The OSS unit 106 is configured to calculate the expected duration to repair each base station 102 by considering the type of failed equipment, expertise level of the one or more technicians, permissions required to access the corresponding base stations 102, and height of antennas and collecting timestamps pertaining to arrival timestamp of the one or more technicians to the corresponding base stations 102, the timestamp of interaction of the one or more technicians with the faulty equipment facilitated by existing or proposed alarms, and the timestamp of resolution of the alarm signal by the one or more technicians.

The one or more sensors integrated into connectors of cables of a radio unit to detect disconnections and generate alarms, with the capability to clear alarms upon reconnections. Generate an additional alarm if an equipment, previously generating an alarm due to failure, is switched off and capture the timestamps indicating the moment when the one or more technicians clear an alarm.

### Decision-Making Process for Drone Deployment Onsite.

The OSS unit 106 is configured to determine a decision to dispatch a drone carrying a radio node, upon the condition that the duration of travel of the drone is less than the sum of the expected duration to repair each base station 102, the estimated time of arrival of the closest technician to the corresponding base stations 102, and a specified margin, wherein the margin is adjustable within a range of 0 to a few minutes, selectable either manually by an operator managing the drone or by artificial intelligence tools based on historical data or characteristics of the corresponding base stations 102.

### Communication of Outage Periods to Subscribers.

The OSS unit 106 is also configured to collect information regarding the outage and communicate the same to subscribers. The information may include information related to when the outage occurred, the impacted geographical area, the estimated period of the outage, and an additional information related to whether a technician or a drone will be reaching the site for recovery. This information is transmitted to the user through any of a mobile application, a Short Message Service (SMS), or a System Information Block (SIB).

Thus, the present disclosure relates to the system enabling onsite technicians to determine the optimal site for recovery among two sites of equal priority, such as gNB1 and gNB2, during an outage. It introduces a system allowing technicians to prioritize site recovery based on weight, wherein technicians may choose a site, such as gNB2, with lower call volume to minimize operator value reduction. The disclosure introduces a system conducting simulated calculations of total outage durations for two sites under various scenarios, serving as a tool for assessing the cost-effectiveness of deploying additional technicians. Furthermore, the system considers scheduled outages and predictions for subsequent outages before dispatching technicians to recover sites, aiming to prevent potential delays in recovering critical sites. Additionally, the disclosure introduces a system for estimating outage durations with enhanced accuracy, considering factors such as travel time, equipment type, and technician skill levels. It further enhances decision-making efficiency regarding the deployment of drones carrying radio nodes to outage sites by accurately estimating outage durations for each site, thus optimizing resource allocation and minimizing downtime. The system also proposes a capability to communicate accurate outage duration estimates to affected subscribers during downtime, enhancing their overall experience. Moreover, the disclosure addresses common issues and implements proposed methods applicable to both traditional networks and open RAN networks.

FIG. 2A illustrates a flowchart depicting a method for prioritizing recovery based on the least total duration of outage for sites of equal weight, in accordance with an embodiment. Referring to FIG. 2A, when two sites of equal weight (equally important) experience an outage, the site to be recovered first is the one that results in the least total duration of outage. At block 202 an initial state wherein the technician responsible for site recovery in an area with gNB1 and gNB2, encounters simultaneous outages at gNB1 and gNB2, both holding equal priority, prompting a decision on which site to prioritize for recovery. For example, the first technician (also referred to as technician 1, herein), responsible for site recovery in a specific area containing gNB1 & gNB2, faces two outages. Initial state: At t1, gNB1 goes down at distance d1 away from a first technician's location Z. Later, at t2, gNB2 goes down at distance d2 from the first technician's initial location Z. During the outage, gNB1 is considered to have equal weight as gNB2. In a first scenario, two calculations are made. A first one, illustrated with formula 1-1 below, consists of calculating the total duration of outage for gNB1 and a second one, illustrated with formula 1-2 below, consists of calculating the total duration of outage for gNB2.
Formula 1-1=Total duration of outage for gNB1 when gNB1 is recovered before gNB2
Formula 1-2=Total duration of outage for gNB2 when gNB1 is recovered before gNB2

At block 204, at time t2 four simulated calculations, designated as formula 1-1 and formula 1-2 in the first scenario and formula 2-1 and formula 2-2 in the second scenario, assess the first technician's sequential recovery approaches for gNB1 and gNB2, each determining outage durations for both gNB1 and gNB2. At t2, the four simulated outage durations are calculated in two scenarios: Scenario 1: The first technician recovers gNB1 before gNB2.
Formula 1-1: (Total duration of outage for gNB1, started at t1, when gNB1 is recovered before gNB2). e.g., (Total duration of outage for gNB1, started at 01h35 am as in FIG. 1A, when gNB1 is recovered first then gNB2)

Formula 1-1 calculates the total duration of the outage for gNB1, starting at 01:35 am, when gNB1 is prioritized for recovery before gNB2. It includes the following durations: the 10-minute travel duration of the first technician from location Z at 01:35 am to location Z1 at 01:45 am, during which the first technician receives notification of gNB2's outage; the remaining 50-minute travel duration from location Z1 to gNB1; and the duration T_repair_gNB1 representing the first technician's on-site repair time. Thus, the formula can be expressed as 10 minutes (the first technician's travel from location Z at 01:35 am to location Z1 at 01:45 am)+50 minutes (remaining travel time from location Z1 to gNB1)+T_repair_gNB1, resulting in a total of 1 hour+T_repair_gNB1.
Formula 1-2: (Total duration of outage for gNB2, started at t2, when gNB1 is recovered before gNB2). e.g., (Total duration of outage for gNB2, started at 01h45 am as in FIG. 1A, when gNB1 is recovered first then gNB2)

Formula 1-2 calculates the total duration of outage for gNB2, initiated at 01:45 am, when gNB1 is recovered before gNB2. It comprises the following five durations: The duration includes the 50-minute travel time from the first technician's location Z1 at 01:45 am to gNB1, during which gNB2 remains in outage.

Once on-site at gNB1, the first technician's repair period, represented by T_repair_gNB1, is considered, during which gNB2 remains in the outage. After recovering gNB1, the first technician returns to gNB2. This involves a one-hour travel from gNB1 back to the first technician's initial location Z and then a 10-minute travel from Z to gNB2. Upon reaching gNB2, the first technician's repair time, represented by T_repair_gNB2, is considered.

In this example, Formula 1-2 yields a duration of 50 minutes (travel from Z1 to gNB1)+T_repair_gNB1+1 hour (travel from gNB1 to Z and back to gNB2)+10 minutes (travel from Z to gNB2)+T_repair_gNB2=2 hours+T_repair_gNB1+T_repair_gNB2. For simplicity of the calculations and in the whole document we consider that T_repair_gNB1 equal to T_repair_gNB2 equal to 10 minutes. Considering both scenarios, Formula 1 calculates the total outage duration for gNB1 and gNB2 as the sum of Formula 1-1 and Formula 1-2. As a result, when scenario 1 is followed, the total duration of outage on gNB1 and on gNB2 is illustrated with Formula 1 and it is equal to (formula 1-1)+ (formula 1-2)=1 h and 10 minutes+2 h and 20 minutes=3 h and 30 minutes.

In the scenario 2, as it was the case with scenario 1, also two calculations are made.

A first one, illustrated with formula 2-1 below, consists of calculating the total duration of outage for gNB2 and a second one, illustrated with formula 2-2 below, consists of calculating the total duration of outage for gNB1.
Formula 2-1=Duration of outage for gNB2 when gNB2 is recovered before gNB1
Formula 2-2: Duration of outage for gNB1 when gNB2 is recovered before gNB1

Scenario 2: The first technician recovers gNB2 before gNB1.
Formula 2-1: (Duration of outage for gNB2, started at t2, when gNB2 is recovered before gNB1). E.g., (Duration of outage for gNB2, started at 01h45 am as in FIG. 1A, when gNB2 is recovered before gNB1)

Formula 2-1 calculates the duration of the outage for gNB2, which begins at 01:45 am, when gNB2 is recovered before gNB1. It comprises the following durations: A 10-minute travel duration of the first technician from location Z1 at 01:45 am to location Z. A 10-minute travel duration of the first technician from location Z to gNB2. The repair time, represented by T_repair_gNB2, required to restore gNB2. In this scenario, Formula 2-1 yields a total duration of 20 minutes (10 minutes travel from Z1 to Z+10 minutes travel from Z to gNB2) plus T_repair_gNB2, which is assumed to be 10 minutes as per the given conditions, resulting in a total duration of 30 minutes. As we considered above that T_repair_gNB2=T_repair_gNB1=10 minutes.
Formula 2-2: (Duration of outage for gNB1, started at t1, when gNB2 is recovered before gNB1). E.g., (Duration of outage for gNB1, started at 01h35 am as in FIG. 1A, when gNB2 is recovered before gNB1)

Formula 2-2 computes the duration of the outage for gNB1, originating at 01:35 am, when gNB2 is restored before gNB1. It encompasses the following durations: A 10-minute duration, as at 01:45 am, gNB1 had already been in an outage for 10 minutes, and the first technician is at location Z1. A 10-minute travel duration of the first technician from location Z1 to location Z. A 10-minute travel duration of the first technician from location Z to gNB2. The repair time, represented by T_repair_gNB2, required to restore gNB2. A 10-minute travel duration of the first technician from gNB2 back to location Z. A one-hour travel duration of the first technician from location Z to gNB1.

The repair time, represented by T_repair_gNB1, is required to restore gNB1. In this scenario, Formula 2-2 results in a total duration of 1 hour and 40 minutes (10 minutes+10 minutes+10 minutes+T_repair_gNB2+10 minutes+1 hour+T_repair_gNB1), which simplifies to 2 hours. The total outage duration for gNB1 and gNB2, according to Formula 2, is computed as the sum of Formula 2-1 and Formula 2-2, equating to (30 minutes)+ (2 hours)=2 hours and 30 minutes.

Without the aid of a tool incorporating valuable criteria for decision-making, the first technician may make suboptimal choices when faced with the decision between recovering gNB1 before gNB2 (scenario 1) or vice versa (scenario 2) at 01:45 am. In the absence of such a tool, following scenario 1 could result in an additional hour of outage duration (3 hours and 30 minutes-2 hours and 30 minutes) compared to scenario 2, highlighting the potential for improved operational efficiency through the implementation of a decision-support system integrating relevant criteria.

At block 206, comparing total outage durations for two recovery scenarios, selecting the scenario with the least outage duration is taken at time t2, and storing results of simulated calculations. Comparison between (Formula 1-1+Formula 1-2) AND (Formula 2-1+Formula 2-2) is performed. The first technician selects the scenario with the lowest total outage duration. If (Formula 1-1+Formula 1-2)< (Formula 2-1+Formula 2-2), then scenario 1 is chosen, and the first technician goes to gNB1 first. Otherwise, scenario 2 is chosen, and the first technician goes to gNB2 first. The results of simulated calculations are stored in a database.

In the event of a third site outage, such as gNB100 at time t3 following the initial downtime of gNB1 and gNB2 at time t2, simulated calculations to assess the total outage duration for all three sites across various recovery sequences is performed. These calculations encompass all possible scenarios, with eight potential combinations for three sites, and based on the outcomes, the first technician is prompted to choose the path resulting in the shortest overall outage duration for all affected sites. Following are two examples of scenarios: In the first scenario, gNB1 is recovered first, gNB2 second and gNB100 third. In a second scenario, gNB2 is recovered first, gNB1 second and gNB100 third. Based on the results of all the simulated calculations performed in all the scenarios, technician 1 will then be asked to select the path that leads to the least total duration of outage for all three sites.

The failure to incorporate comprehensive criteria, beyond solely total outage duration, when prioritizing site recovery decisions poses a significant challenge in existing solutions. For instance, when considering criteria such as the number of call requests processed per hour by each site, a scenario arises where gNB1, processing a higher volume of calls compared to gNB2, necessitates a different recovery strategy. Despite both scenarios resulting in outage durations of 3 hours and 30 minutes for gNB1 prioritization and 2 hours and 30 minutes for gNB2 prioritization, respectively, a suboptimal decision may occur if the first technician returns to recover gNB2 before gNB1 at 01:45 am. Thus, the absence of a comprehensive approach that accounts for diverse criteria when dispatching technicians exacerbates operational inefficiencies and underscores the need for innovation in decision-making frameworks within this domain. To overcome the said limitations, FIG. 2B is disclosed. FIG. 2B illustrates a flow chart of a method for determining priority for technician deployment based on site weight discrepancies, in accordance with an embodiment. Determining priority for technician deployment based on site weight discrepancies and factors influencing weight assignment, where sites are prioritized for recovery based on various criteria such as historical call performance, number of Radio Access Technologies (RAT) running on a site, site configuration, covered area, and other relevant factors, ensuring efficient resource allocation during outages.

For example, if a site, such as gNB1, has a higher historical call volume compared to another site, gNB2, it may be assigned a higher weight, guiding the technician to prioritize its recovery. Additionally, factors like the number of RATs, site configuration (e.g., micro or macro), and coverage area influence the weight assignment, ensuring efficient site recovery based on predefined criteria.

In another aspect, the method accounts for the comparison of weights across different categories, such as prioritizing a 5G site covering a hospital over another 5G site in a busy city center, despite potential differences in call volume. Additionally, certain sites, designated as highly important by the operator, trigger a policy where a technician must prioritize their recovery over other sites, regardless of their assigned weight. As such, when facing multiple sites with varying weights during outages, the technician is advised on which site to recover first, with the assumption that none of the sites are deemed highly important.

At block 208 assigning the first technician to recover sites in an area with gNB1 and gNB2, detecting outages at gNB1 and gNB2 at times t1 and t2 respectively, where gNB1 holds more weight than gNB2 during the outage period. Assigning a field technician, herein referred to as the first technician, with responsibility for recovering sites in a designated area containing gNB1 and gNB2. Identify at t1 an outage at a first site, gNB1, located at a distance d1 away from location Z of the first technician. Identify at t2 an outage at a second site, gNB2, located at a distance d2 from the first technician's initial location Z, wherein at t2 the first technician has not yet reached gNB1 and may be enroute from location Z towards gNB1 or remaining at initial location Z.

At block 210 performing four simulated calculations at time t2. Performing four simulated calculations at time t2 involves utilizing the calculations previously derived from the first attribute for both scenario 1 (where gNB1 is recovered first) and scenario 2 (where gNB2 is recovered first), which include Formula 1-1, Formula 1-2, Formula 2-1, and Formula 2-2, determining outage durations for gNB1 and gNB2 under different recovery sequences.

At block 212 integrating weight considerations into the results of the four simulated calculations conducted at time t2. In this step, the weight of each site in outage is incorporated into the respective formulas, resulting in four new formulas labeled as follows: Formula 1-1′, Formula 1-2′, Formula 2-1′, and Formula 2-2′, calculated by multiplying the durations of outage for gNB1 and gNB2 in each scenario by their respective weights.

$$Formula 1 - 1 ’ = Formula 1 - 1 ( Duration of outage for gNB 1 in scenario 1 ) \times weight of gNB 1$$

$$Formula 1 - 2 ’ = Formula 1 - 2 ( Duration of outage for gNB 2 in scenario 1 ) \times weight of gNB 2$$

$$Formula 2 - 1 ’ = Formula 2 - 1 ( Duration of outage for gNB 2 in scenario 2 ) \times weight of gNB 2$$

$$Formula 2 - 2 ’ = Formula 2 - 2 ( Duration of outage for gNB 1 in scenario 2 ) \times weight of gNB 1$$

At block 214 determining the decision on which site to recover first at time t2 by comparing the results of four simulated calculations, where the outage durations, adjusted by the weights of the sites, are analyzed across different recovery scenarios. This step involves comparing the sum of the adjusted outage duration formulas for each recovery scenario, specifically (Formula 1-1′+Formula 1-2′) and (Formula 2-1′+Formula 2-2′). At time t2 to determine the scenario with the least impact for the operator, and communicating this decision to the onsite technician e.g., if (Formula 1-1′+Formula 1-2′)< (Formula 2-1′+Formula 2-2′) Scenario 1 is selected and hence technician 1 may go first to the gNB1. Otherwise, Scenario 2 is selected and hence technician 1 may go first to the gNB2. The results are stored in the database. For instance, if the weight of each site is based on the number of requested calls per hour, with gNB1 handling 300 calls per hour and gNB2 handling 30 calls per hour, the outage durations for each site are calculated based on their respective weights and the timing of the outages.

Scenario 1 in Case gNB1 is Recovered Before gNB2

$$Formula 1 - 1 ’ = ( 1 h and 10 minutes ) \times 300 calls per hour = 350 calls lost ( due to the outage on gNB 1 ) .$$

$$Formula 1 - 2 ’ = ( 2 h and 20 minutes ) \times 30 calls per hour = 70 calls lost ( due to the outage on gNB 2 ) .$$

Scenario 2 in Case gNB2 is Recovered Before gNB1

$$Formula 2 - 1 ’ = ( 30 minutes ) \times 30 calls per hour = 15 calls lost ( due to the outage on gNB 2 ) .$$

$$Formula 2 - 2 ’ = ( 2 h ) \times 300 calls per hour = 600 calls lost ( due to the outage on gNB 1 ) .$$

The total number of calls on both sites caused by the outage would be in case the first technician recovers gNB1 first (scenario 1), (Formula 1-1′+Formula 1-2′)=(350 calls on gNB1+70 calls on gNB2)=420 lost calls. Whereas, in case the first technician recovers gNB2 first (scenario 2), (Formula 2-1′+Formula 2-2′)=(15 calls on gNB2+600 calls on gNB1)=615 lost calls.

The total calls lost for each scenario, (Formula 1-1′+Formula 1-2′) and (Formula 2-1′+Formula 2-2′), are compared to select the scenario with the least damage, informing the first technician to recover gNB1 first. The importance of site weight is highlighted, where the decision varies based on the weight disparity between gNB1 and gNB2. Furthermore, discrepancies in call losses between scenarios are logged in a database, facilitating ongoing assessment by the operator. The system recognizes that when two sites, such as gNB1 and gNB2, possess equal weight, prioritizing the recovery of gNB2 first by the first technician optimizes operator value. Conversely, when gNB1 holds greater weight, prioritizing its recovery first enhances operator value. Thus, weight significantly influences the selection of the initial site for recovery during network outages.

FIG. 2C illustrates a flow chart of a method of comparing the cost of the total duration of outage with one technician in the field to the cost of the total duration of outage when more than one technician is in the field, in accordance with an embodiment. The wireless operator determines the cost-effectiveness of either retaining one technician with a monthly salary to address outages across all sites within a specified geographical area, such as areal, or hiring an additional technician with an extra monthly salary to collectively manage site outages within that areal.

At block 216 assessing initial outages at sites gNB1 and gNB2 with the first technician. In an embodiment, assess the initial state, including the presence of field the first technician responsible for recovering sites gNB1 and gNB2 in the designated area. Identify the occurrence of an outage at the first site, gNB1, at time t1, situated at distance d1 away from location Z of the first technician. Subsequently, identify the outage at the second site, gNB2, at time t2, located at distance d2 from the first technician's initial location Z. Analyze the effectiveness of deploying an additional technician in the field to recover the sites. Evaluate the comparative cost implications of total outage duration with one technician versus multiple technicians in the field. Determine whether it is advantageous for the operator to employ an additional technician based on the analysis and present the findings to the operator to aid in decision-making regarding technician deployment strategies.

At block 218 determining the cost of handling gNB1 and gNB2 that are down at time t2 with a single technician.

Case 1: Cost with single technician: At time t2, simulate durations of outages for gNB1 and gNB2 in two scenarios:
Scenario 1: First Technician recovers gNB1 before gNB2.
Scenario 2: First Technician recovers gNB2 before gNB1.
In case of equal weight sites, compare total outage durations between Scenario 1 and Scenario 2 to select the scenario that leads to the least duration of outage. Convert selected outage duration into monetary units (MU) denoted as x_MU.
In case of different weight sites, select the scenario that leads to the least damage for the operator. Convert the cost of the selected scenario, e.g. number of calls, into monetary units (MU) denoted as x′ MU.

At block 220 determining the cost of handling gNB1 and gNB2 that are down at time t2 with two technicians.

Case 2: Cost with Two Technicians: At time t2, assume technician 2 is present with the first technician at location Z. At time t1 when the first site gNB1 went into outage, technician1 goes to gNB1 to recover it, a simulated duration of outage of gNB1 is calculated and denoted as formula 3-1. Later, at time t2, when gNB2 in example goes down, the second technician, technician2, goes to gNB2 in order to recover it and a simulated duration of outage of gNB1 is calculated and denoted as formula 3-2.

Convert the total outage duration for gNB1 & gNB2 when two technicians are available (Formula 3-1+Formula 3-2) into MU. In case equal weight sites, convert the total duration of outage represented by (Formula 3-1+Formula 3-2) into MU, denoted as y_MU. In case different weight sites, convert the total damage, e.g. number of calls represented by (Formula 3-1+Formula 3-2), including the weight of each site, into MU, denoted as y′_MU.

If the total duration (case of equal weight sites) or the minimum damage to the operator (case of different weight sites) is used: Calculate the difference between the converted MU value (x_MU or x′_MU) and (y_MU or y′_MU), (x_MU-y_MU) and (x′_MU-y′_MU) is then denoted as difference_in_outage_in_MU. Compare the gain difference_in_outage_in_MU over a specified period (e.g., monthly or yearly) with the salary of the potential second technician. Use the comparison result to determine whether employing an additional technician is justified for the operator.

FIG. 2D illustrates a flow chart of a method for integrating output from outage prediction tools and scheduled outages, in accordance with an embodiment. Referring to FIG. 2D, the system can determine technician dispatch based on outage prediction tool output and planned outage scheduling. At time t1, if a site (e.g., gNB1) experiences an outage, the decision to dispatch a technician immediately is contingent upon the prediction that another site (e.g., gNB2) may not experience an outage close to time t1. If no outage is anticipated for gNB2 at time t2 close to t1, the technician is instructed to recover gNB1 promptly. However, if an outage for gNB2 is expected at t2, the technician may not be dispatched immediately for gNB1; instead, it may be deemed more efficient to prioritize the recovery of gNB2 before gNB1.

At block 222 assigning the first technician to recover sites gNB1 and gNB2, implement an outage prediction tool at the OSS for forecasting, and direct the first technician to respond to detected outages. In an aspect, assign the first technician to the task of site recovery within a specified area containing gNB1 and gNB2. Implement the prediction tool within the network, such as at the OSS, capable of forecasting site outages.

At block 224, reviewing expected output before responding to site outages. In an aspect, upon the occurrence of the site outage in the network, such as at time t1 when gNB1 experiences a failure, the process of verifying, before initiating immediate response actions, represented by directing the first technician to gNB1 at t1, the anticipated output provided by the planned outage entity at the OSS and the outage prediction tool, to ascertain the likelihood of another site, for instance, gNB2, expected to encounter an outage at a subsequent time t2, where t2 exceeds t1.

At block 226, assessing absence of concurrent site outages during gNB1 failure. If there are no scheduled or predicted outages anticipated around time t1, the first technician proceeds directly to gNB1 at t1 to commence recovery operations.

At block 228, anticipating at least one site outage around the time of gNB1's outage. If, prior to sending the first technician to the site at time t1, there are indications from a planned outage entity or a predicted outage tool of potential site failures at time t2, simulated calculations determining the optimal recovery sequence for gNB1 and gNB2 are performed at t1, considering scenarios where the first technician waits until t2, enabling informed decision-making regarding prioritization of site recovery. These calculations mirror those conducted in previous attributes, accounting for differences in site weights.

For example, in scenario 1, the first technician prioritizes the recovery of gNB1 before gNB2, involving simulated calculations of outage durations for both gNB1 and gNB2, considering equal weight scenarios (formula 1-1 for gNB1 and formula 1-2 for gNB2) and different weight scenarios (formula 1-1′ for gNB1 and formula 1-2′ for gNB2). In scenario 2, the first technician prioritizes the recovery of gNB2 before gNB1, similarly conducting simulated calculations for both sites in equal weight (formula 2-1 for gNB2 and formula 2-2 for gNB1) and different weight (formula 2-1′ for gNB2 and formula 2-2′ for gNB1) situations. At block 230, based on the outcomes of the above simulated

calculations, a determination is made regarding whether to dispatch the first technician for the initial recovery of gNB1 at time t1 or to delay until time t2 for the prioritized recovery of gNB2 by the first technician.

The comparison is made between the sums of simulated formulas for scenario 1 and scenario 2, considering equal and different weights for the sites. If the sum of simulated formulas in scenario 1 is less than that of scenario 2, the first technician is directed to recover gNB1 first at time t1, followed by gNB2. Conversely, if the sum of simulated formulas in scenario 1 is greater than that of scenario 2, the first technician remains at location Z until time t2, then proceeds to recover gNB2 first, followed by gNB1.

For example, in case the two sites have equal weight, a comparison, between the sum of the simulated formulas in scenario 1 that is (formula 1-1+formula 1-2) and the sum of the simulated formulas in scenario 2 that is (formula 2-1+formula 2-2), is performed. In case the two sites have different weights, a comparison, between the sum of the simulated formulas in scenario 1 that is (formula 1-1′+formula 1-2′) and the sum of the simulated formulas in scenario 2 that is (formula 2-1′+formula 2-2′), is performed.

Then, if (formula 1-1+formula 1-2)< (formula 2-1+formula 2-2) or (formula 1-1′+formula 1-2′)< (formula 2-1′+formula 2-2′) then scenario 1 is selected and the first technician may go at t1 to gNB1 in order to recover it first. Then after recovering gNB1 move to gNB2 to recover it. Otherwise, if (formula 1-1+formula 1-2)> (formula 2-1+formula 2-2) or (formula 1-1′+formula 1-2′)> (formula 2-1′+formula 2-2′) then scenario 2 is selected and hence at t1, the first technician may not move towards gNB1 rather he may remain at its location Z till time t2 and then goes to recover gNB2 first. Then after recovering gNB2 move to gNB1 to recover it.

FIG. 2E illustrates a flow chart of a method for calculating the duration for fixing an issue, in accordance with an embodiment. The software entity, referred to as entity_T_repair_estimation, operates within the network infrastructure to estimate the duration (T_repair_gNBi) required for an onsite technician to recover faulty equipment at a specific site (gNBi). This estimation is based on inputs including the type of faulty equipment, the expertise level of the technician, the time required to obtain access permission to the site, and the height of the antennas if applicable. The duration encompasses accessing the site, reaching the equipment location (either within a cabinet or at the antennas), and executing repair procedures, with variations based on technician expertise and site-specific factors.

At block 232 determining site recovery duration (T_repair_gNBi) upon technician arrival at an outage site, comprising assessing factors including type of equipment failure, onsite technician expertise, site access permission, and antenna height. Upon technician arrival at a site experiencing an outage, identify the factors influencing site recovery duration, denoted as T_repair_gNBi:
a. Type of equipment failure
b. Onsite technician expertise
c. Site access permission
d. Antenna height

In an aspect, the determination of the type of faulty equipment is integral, as the duration of outage varies based on the specific equipment involved. For instance, the replacement of a defective fan, battery, or standby DU typically requires a short duration, generally less than 5 minutes. However, in the case of a faulty active DU, besides card replacement, additional configuration tasks such as setting IP addresses and adjusting cell numbers may be necessary, extending the repair time significantly, potentially up to 30 minutes. In situations where the equipment is housed within a cabinet, the time taken to access the cabinet from the moment the technician arrives at the site is denoted as T_reach_cabinet_gNBi, where ‘i’ denotes the site's identity (gNB).

The expertise of the onsite technician plays a significant role in the repair process, as certain procedures may be required beyond simple equipment replacement. Variation in repair durations stems from differences in technicians' proficiency and prior experience with specific tasks. The duration to repair a particular equipment type (X) by a technician (Y) is denoted as T_repair_equipmentX_technicianY, where X represents the equipment type (e.g., X=1 for a fan, X=2 for a Remote Unit (RU), etc., and each distinct value of Y corresponds to an individual technician.

The necessity of access permission to the site within a mobile wireless network is acknowledged, with the majority of sites typically allowing immediate entry. However, certain locations may mandate special permission, causing delays in repair activities until clearance is obtained. Examples include sites situated atop buildings or within restricted premises such as police stations. Additionally, instances where access keys are provided by landlords, thus potentially impeding technician entry, are considered. The duration required to obtain access permission for a specific site (gNBi) is denoted as T_permission_access_gNBi within the patent context.

Considering the height of antennas is crucial for estimating repair time, particularly in sites where antennas are installed at elevated locations to enhance radio coverage. In such scenarios, technicians may need to ascend long staircases to access antennas and associated remote units (RUs). This consideration extends beyond faulty RU equipment to include instances where antennas or associated cabling, such as coaxial and fiber optic cables, require maintenance. The duration required to reach antennas at a specific site (gNBi) is denoted as T_reach_antennas_gNBi. As a result of all the above four factors, the total repair duration for site gNBi, denoted as T_repair_gNBi, is the sum of the durations related to the four factors described above. This gives T_repair_gNBi=T_reach_cabinet_gNBi (in case the fault is related to the cabinet of the site)+T_repair_equipmentX_technicianY+T_permission_access_gNBi+T_reach_antennas_gNBi (in case the fault is related to the antenna).

At block 234 a procedure to be used for a new site not visited by a technician by utilizing preconfigured durations and employ AI and ML units to calculate T_repair_gNBi:

In an embodiment, for new sites not previously visited by a technician, utilize one or both of the following procedures to calculate T_repair_gNBi:
a. Use preconfigured durations, such as preconfigured antenna height on the OSS.
b. Employ AI and ML technology to predict antenna height based on photos or existing similar building data.

Use preconfigured durations, such as preconfigured antenna height on the OSS: Predefined values for the estimated duration of each component of T_repair_gNBi (T_permission_access_gNBi; T_reach_cabinet_gNBi or T_reach_antennas_gNBi; T_repair_equipmentX_technicianY) are configured at the OSS based on the specific site to be visited and the type of equipment likely to become faulty. These values are manually set by operator staff.

Employ AI and ML technology to predict antenna height based on photos or existing similar building data: When a notification of equipment outage is received, an AI and ML entity implemented at the network side, such as the OSS_AI&ML_entity_repair, accesses the configuration of each site in the network to retrieve historical data on similar previous scenarios, providing estimated durations for each component of T_repair_gNBi.

For T_reach_cabinet_gNBi, building information obtained previously may be utilized, excluding details about landlords, as this duration starts after technician access is granted. In cases where no permission is required, T_reach_cabinet_gNBi corresponds to the duration needed for the technician to reach the equipment from the site location.

For T_repair_equipmentX_technicianY, data is gathered from previous repairs conducted by the assigned technician or from average values derived from similar repairs executed by other technicians. These records inform repair duration estimates for specific equipment types performed by designated technicians.

For T_permission_access_gNBi, the OSS_AI&ML_entity_repair utilizes information such as building type, landlord details, and rental agreements to determine if permission access is required for the site. This determination may involve analyzing factors such as building photos and rental agreements. If no access permission is necessary, T_permission_access_gNBi is considered as zero.

For T_reach_antennas_gNBi, OSS_AI&ML_entity_repair receives inputs from either configured value in the OSS or photos captured during antenna installation. Configuration values include antenna height and site parameters, while photos aid in assessing antenna installations, particularly beneficial for antennas at elevated heights or difficult-to-access locations.

At block 236, after a first visit to a new site, the following timestamps are used in order to calculate an accurate value of T_repair_gNBi, the repair time (T_repair_gNBi) is calculated as the difference between the timestamp when the technician cleared the alarm (t3) and when they arrived at the site (t1) (t3-t1). The time to access the site which needs access permission is determined by the difference between the timestamps when the technician touched the faulty equipment (t2) and when they arrived at the site (t1) (t2-t1).

After the initial visit to a new site, utilize timestamps to accurately calculate T_repair_gNBi:
a. timestamp of technician arrival at the site (t1).
b. the timestamp of technician contact with faulty equipment (t2), facilitated by existing alarms within the cabinet or proposed alarms for RU
c. the timestamp of alarm clearance by the technician (t3).

Based on the recorded timestamps, calculate T_repair_gNBi as the difference between t3 and t1 (t3−t1). Determine the time taken to access the site (t2−t1), valuable if site access permission is required.

For example, the timestamp when the technician has arrived to the site, e.g. at time t1 could be reported by the computing device 108 to the OSS unit 106. The timestamp when the technician has touched the faulty equipment, e.g. at time t2 is possible to existing alarms, e.g. when the faulty equipment is inside the cabinet, or to new proposed alarms in case it is related to RU. The timestamp when the technician has cleared the alarm, e.g. at time t3. Based on the above timestamps: t3−t1 is equal to T_repair_gNBi and t2−t1=time to access the site which is useful in case the site needs access permission.

The system for calculating the duration of each component of T_repair_gNBi, comprising: a technician tracking entity, such as the mobile_app_technician_in_outage, configured to record timestamps (timestamp_technician_enter_site, timestamp_technician_exit_site) indicating the technician's arrival and departure from the geographical location of gNB1. Such procedure might give a value of T_repair_gNBi as being equal to (timestamp_technician_exit_site-timestamp_technician_enter_site), however, it will not reveal the value of each component of T_repair_gNBi which are (T_permision_access_gNBi, T_reach_cabinet_gNBi or T_reach_antennas_gNBi, T_repair_equipmentX_technicianY).

Two procedures might then be used to calculate the duration of each these three durations: Manual input from the technician is used to determine the values of T_permision_access_gNBi, T_reach_cabinet_gNBi, and T_reach_antennas_gNBi in a first method, and wherein automatic collection of such information from the network, specifically from the OSS, is utilized in a preferred second method. Procedure 1 is employed when the faulty equipment is located inside the cabinet of gNB1 and procedure 2 is employed when the faulty equipment is located outside the cabinet.

For Procedure 1 (Case where the faulty equipment is located inside the cabinet): the technician, receives, from the OSS unit 106, an alarm signal upon the opening of the cabinet door, and the alarm is cleared upon the closure of the door. Importantly, the third component of T_repair_gNB1, representing T_reach_antennas_gNBi, is rendered irrelevant as the fault pertains solely to equipment contained within the cabinet, with no involvement of components related to antennas or Remote Units (RU).

The calculation of T_repair_gNBi is performed under two distinct scenarios: the first technician arrives at site gNB1 at time t1, the cabinet door is opened at time t2, the card replacement takes place at time t3 generating a clearance of the initial faulty equipment alarm, and the door is closed at time t4. The two distinct scenarios are as follows:

No Permission Access Required: If the site does not require permission access, the repair time is computed as follows:

$$T\_permission \_access \_gNBi = 0 ( no additional time for permission access )$$

$$T\_reach \_cabinet \_gNBi = t 2 - t 1 ( time taken to reach the cabinet )$$

$$T\_repair \_equipmentX \_technicianY = t 3 - t 2 ( time taken to fix the issue , e . g . replace a faulty equipment , update and configure software )$$

Permission Access Required: If the site requires permission access, the repair time incorporates the duration of permission access (T_permission_access_gNBi), which may be manually entered by the technician or retrieved from the OSS:

$$( T\_permision \_access \_gNBi + T\_reach \_cabinet \_gNBi ) = t 2 - t 1$$

$$T\_repair \_equipmentX \_technicianY = t 3 - t 2$$

For Procedure 2 (Case where the faulty equipment is connected to the antennas or to the RU): In a second case where the RU equipment is identified as faulty and has already triggered an alarm before the technician's arrival at the site, determining the time when the technician reaches the antennas becomes challenging. The problem is that as the alarm related to the RU was already generated then when the technician touches the faulty RU actual no new alarm is generated and hence there is no knowledge on when the technician has reached the faulty equipment. Consequently, the calculation of t2−t1 is not feasible, leaving only the time of equipment recovery, t3−t1, known. To address this issue and enable autonomous calculation of t2, two additional procedures are proposed:

In the preferred procedure, upon switching off, by the onsite technician, a faulty RU that has already generated an alarm, a second alarm is generated at the OSS, providing the timestamp t2. Alternatively, in an optional procedure, sensors are installed on all cables connected to the RU. These sensors are designed to trigger an alarm at the OSS each time a cable is disconnected, indicating the moment when the technician touches the antennas (t2). The total repair duration is then computed based on whether

permission access is required and the duration for reaching the antennas. These procedures are devised to streamline the calculation of individual repair duration components for effective outage management during technician visits.

FIG. 2F illustrates a flowchart depicting a method for determining the deployment of a drone to a specific site, in accordance with an embodiment. In some situations, the operator of the wireless network might deploy a drone carrying a radio node to either cover a congested geographical area (e.g., area_congested) or provide radio coverage to an area lacking coverage (e.g., area_out-of-coverage) due to cell outage(s). In such cases, to assist the operator in making the best decision regarding whether to deploy a drone carrying a radio node to the area_congested or area_out-of-coverage is disclosed.

At block 238 the decision to deploy a drone onsite at the drone station depends on three types of information: the geographical coordinates of the site in outage, aiding in estimating drone travel duration; the expected arrival time of the nearest technician, obtained from technician dispatch management; and the repair duration estimate for the site, derived from a preceding feature output. At the drone station, the decision-making process for deploying a drone onsite relies on access to three types of information: the geographical coordinates of the site in outage, enabling estimation of the drone's travel duration (T_travel_drone_to_gNB1); the anticipated time of arrival of the closest technician to the site (T_travel_technician1_to_gNB1), obtained from the entity managing technician dispatch; and the estimated duration of repair for the site (T_repair_gNBi), derived from the output of a preceding feature.

At block 240 decision on whether to deploy a drone carrying radio node onsite is made based on a formula comparing the drone's travel time to the site against the sum of the anticipated technician's travel time, repair duration, and an adjustable margin parameter to compensate for estimation errors, with the drone being dispatched if the formula condition is met, otherwise remaining at the station

For example, if T_travel_drone_to_gNB1<T_travel_technician1_to_gNB1+T_repair_gNBi+margin_operator then the drone is sent onsite. Where margin_operator is an optional parameter, that takes the values from 0 to a few minutes that might be taken by the operator, e.g. in order to compensate any error in the estimation of T_repair_gNBi and where the value of the margin parameter could be either set manually by an operator or by some artificial intelligence tools that select a value based on previous visits to that site in outage or to other sites. Alternatively, if the above formula is not validated then the drone is not sent to the site.

FIG. 2G illustrates a flowchart depicting a method for communicating the outage period to subscribers, in accordance with an embodiment. The mobile phone subscribers are notified about the geographical area impacted by a cell outage and the expected duration of the outage. At block 242, at time t1, a 5G site, exemplified by gNB1, encounters a failure.

At block 244, the OSS unit 106 communicates outage information to the subscribers based on the collect information regarding an outage event. The OSS unit 106 at the network side is configured to communicate outage information to the subscribers based on two primary functions:

Collect information regarding an outage event, such as the occurrence time (e.g., t1), affected geographical area (e.g., location of gNB1), estimated duration of outage (T_repair_gNB1), and any additional details regarding technician or drone deployment. For example, collect information about an outage, gNB1. This mainly includes when the outage has occurred, e.g., at t1, the impacted geographical area, e.g., location of gNB1, the estimated period of the outage that is T_repair_gNB1 calculated with fifth attribute above. An additional information, on whether a technician and/or drone carrying a radio node may be reaching the site.

Communicate the collected outage information to subscribers through preferred channels, including a dedicated mobile application denoted mobile_app_for_technician_in_outage as shown in FIG. 1B, downloadable from the operator's server, short message service (SMS), or cell broadcasted signaling e.g., system information block, (SIB).

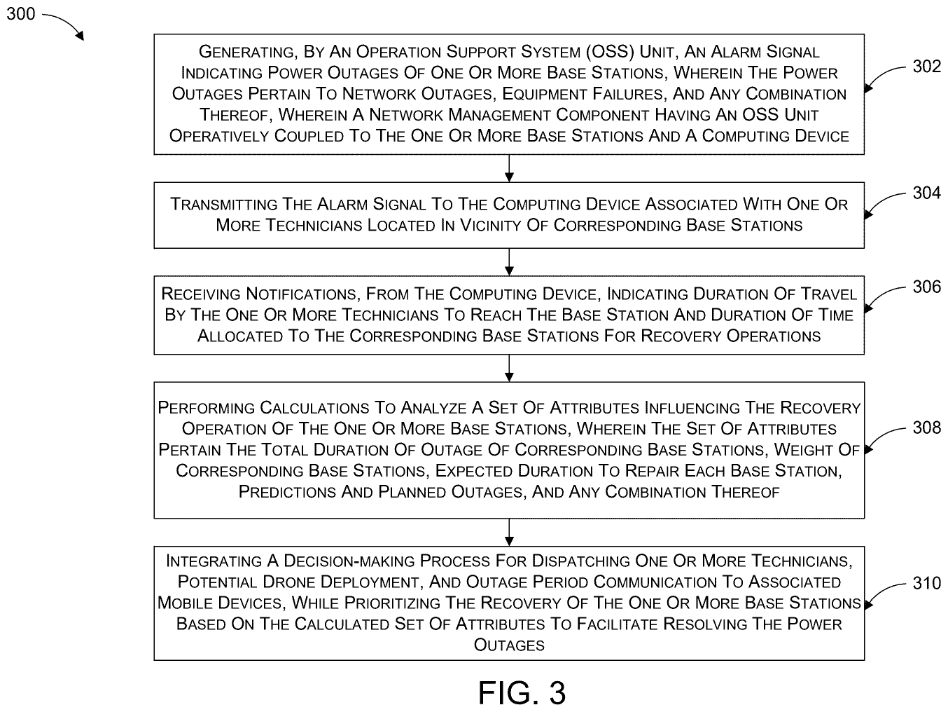

FIG. 3 illustrates a flowchart of an exemplary method for managing outages, in accordance with an embodiment of the present disclosure.

At step 302, on occurrence of outages of one or more base stations 102 in the network the OSS unit generates an alarm signal regarding the outage which can be caused by network outages, equipment failures and a combination of both. At step 304, the alarm signal is transmitted to a computing device 108, wherein the computing device 108 is in communication with one or more technicians in the vicinity of the corresponding base stations 102 facing the outage. At step 306, the technicians receive notifications from the computing device 108 via a mobile app indicating the duration of time that is allocated to the corresponding base stations 102 for conducting recovery operations.

At step 308, the OSS unit 106 performs a set of calculations related to the recovery operation of the corresponding base stations 102. The calculations are related to analysing a set of attributes including total duration of the outage of corresponding base stations 102, the weight of the corresponding base stations 102, the expected duration to repair each base station 102, and any predictions and planned outages in the network and a combination of attributes thereof.

At step 310, the method includes a decision-making process for dispatching the one or more technicians, or even a potential drone employment depending on the scenario. The outage period information is communicated to the associated mobile device with a priority emphasis on the recovery of the one or more base stations 102, based on the analysis and calculations related to the set of attributes to facilitate resolving the outages.

It is to be appreciated by a person skilled in the art that while various embodiments of the present disclosure have been elaborated for a system and method for managing outages in a network. However, teachings of the present disclosure are also applicable for other types of applications as well, and all such embodiments are well within the scope of the present disclosure. However, a system and method for managing outages in a network and all such embodiments are well within the scope of the present disclosure without any limitation.

### Advantages of the Present Disclosure

The present disclosure relates to a system that enables onsite technicians to determine the optimal site for recovery among two sites of equal priority, such as gNB1 and gNB2, during an outage.

The present disclosure introduces a system that allows technicians to prioritize site recovery during outages based on weight.

The present disclosure introduces a system that conducts simulated calculations of total outage durations for two sites under two scenarios: one technician recovering both sites and two technicians recovering each site individually. This serves as a tool for operators to assess the cost-effectiveness of deploying additional technicians during simultaneous outages.

The present disclosure introduces a system that considers the outcome of scheduled outages and predictions for subsequent outages before dispatching technicians to recover sites experiencing current outages. The system aims to prevent potential delays in recovering more critical sites, such as gNB2, which may experience outages after the initial site, gNB1.

The present disclosure introduces a system for estimating the outage duration of each site, denoted as T_repair_gNBi, with enhanced accuracy compared to existing methods. This feature calculates T_repair_gNBi from the moment the technician departs their location to the site until they leave after recovery, incorporating various factors such as travel time, equipment type, site access permissions, antenna height, and technician skill levels.

The present disclosure introduces a system that enhances decision-making efficiency regarding deploying drones carrying radio nodes to sites experiencing outages by accurately estimating the outage duration, T_repair_gNBi, for each site. This system addresses the existing issue in current solutions where sites are recovered while drones are enroute, thereby optimizing resource allocation and minimizing downtime.

The present disclosure introduces a system featuring a proposed capability to communicate accurate outage duration estimates, T_repair_gNBi, to affected subscribers when a 5G site experiences downtime. This feature enables subscribers to better plan their activities and usage of applications, enhancing their overall experience during service interruptions.

The present disclosure introduces a system that addresses common issues and implements proposed methods applicable to both traditional networks and open RAN networks.

I claim:

1. A system (100) for managing outages in a network, the system (100) comprising:
a computing device (108) associated with one or more technicians;
a network management component (104) operatively coupled to one or more base stations (102) and the computing device (108), the network management component (104) having an OSS unit (106) configured to:
generate an alarm signal indicating the outages of one or more base stations (102), the outages pertain to network outages, equipment failures and any combination thereof;
transmit the alarm signal to the computing device (108) associated with the one or more technicians located in vicinity of corresponding base stations;
receive notifications, from the computing device (108), duration of travel by the one or more technicians to reach the base station and duration of time 15 allocated to the corresponding base stations for recovery operation;
perform calculations to analyze a set of attributes influencing the recovery operation of the one or more base stations, wherein the set of attributes pertain to total duration of outage of each base station (102), weight of each base station (102), expected duration to repair each base station (102), predictions and planned outages 20 of the one or more base stations (102) and any combination thereof; and
integrate decision-making process for dispatching one or more technicians, potential drone deployment, and communicating outage period to associated mobile devices, while prioritizing recovery of the one or more base stations (102) based on the calculated set of attributes to facilitate resolving the outages.

2. The system (100) as claimed in claim 1, wherein the OSS unit (106) is configured to:
manage the outages of the one or more base stations (102) of equal weight experiencing the outage at different times t1 and t2, respectively;
calculate outage durations under different recovery strategies, wherein the different recovery strategies comprises:
a first strategy that recovers a first base station (102-1) before a second base station (102-1);
a second strategy that recovers the second base station (102-2) before the first base station (102-1);
consider distances and repair durations of the corresponding base stations (102);
compare the total outage durations for each strategy to determine the strategy with least total outage duration;
instruct the one or more technicians on the strategy to follow;
provide detailed information to the one or more technicians regarding the repair duration required for each base station (102).

3. The system (100) as claimed in claim 1, wherein the OSS unit (106) on a first side accesses various software units at the network management component, the software units configured to:
provide a self-healing tool;
provide the total duration of outage on the corresponding base stations for each type of faulty equipment, with consideration to presence of the one or more technicians at the respective base stations;
provide the weights of each base station;
provide outcomes of a planned outage tool and an outage prediction tool, wherein the OSS unit (106) is operatively coupled to a server (110) that accesses a drone station and the computing device (108) associated with the one or more technicians through any or a combination of terrestrial wireless communication and non-terrestrial wireless communication,
wherein the OSS unit (106) on the second side, receives information from the computing device (108) related to the duration of the travel of the one or more technicians to reach corresponding base stations in outage and the timestamps indicating entry of the corresponding technicians, interaction with faulty equipment, and departure of the corresponding technicians from the corresponding base stations.

4. The system (100) as claimed in claim 1, wherein the computing device (108) is configured to:
perform calculations to analyze the set of attributes influencing the recovery operation of the one or more base stations (102), the set of attributes pertain to total duration of outage of each base station (102), the weight of each base station (102), the expected duration to repair each base station (102), predictions and planned outages of the one or more base stations (102) and any combination thereof, wherein the set of attributes are available at the computing device (108) or received from the OSS unit (106); and
integrate decision-making process prioritizing recovery of the one or more base stations (102) based on the calculated set of attributes to facilitate resolving the outage.

5. The system (100) as claimed in claim 1, wherein the OSS unit (106) is configured to calculate the expected duration to repair each base station (102) by:
considering type of failed equipment, expertise level of the one or more technicians, permissions required to access the corresponding base stations, and height of antennas;
utilizing preconfigured durations and employing machine learning engine on the available information at the network management component (104);
collecting the timestamps pertaining to arrival timestamp of the one or more technicians to the corresponding base stations, the timestamp of interaction of the one or more technicians with the faulty equipment facilitated by existing or proposed alarms, and the timestamp of resolution of the alarm signal by the clearance of an existing alarm at the network management component (104).

6. The system (100) as claimed in claim 1, wherein the OSS unit (106) is configured to:
manage the outages of the one or more base stations (102) of different weights experiencing the outage at different times t1 and t2, respectively;
perform calculations at time t2 to simulate the total duration of the power outages for each base stations (102) in different strategies comprises:
a first strategy that recovers the first base station (102-1) before the second base station (102-2);
a second strategy that recovers the second base station (102-2) before the first station (102-1);
consider the distance of the corresponding base stations (102) from the vicinity of the one or more technicians, the expected duration to repair each base station (102), and the weights of each base station (102);
compare sums of the outage durations multiplied by the weights of corresponding base stations (102) for each strategy;
select the strategy resulting in less damage to the network; and
instruct the one or more technicians on optimal strategy.

7. The system (100) as claimed in claim 1, wherein the OSS unit (106) is configured to:
determine the weights of each base station (102) by analyzing different categories including historical call performance, number of Radio Access Technologies (RAT) deployed, cell size, coverage area type, and any combination thereof; and
compare the weights of the different categories to prioritize the corresponding base stations (102), prioritizing a first base station (102-1) covering a medical facility over a second base station (102-2) densely populated urban area despite lower call volume.

8. The system (100) as claimed in claim 1, wherein the OSS unit (106) is configured to:
perform two types of simulated calculations at time t2 when the one or more base stations (102), with equal or different weights, go into the outage at times t1 and t2 respectively, wherein the two types of simulated calculations comprise:
a first simulation that calculates the total outage duration of each base station (102) under two recovery scenarios, selecting the scenario resulting in the least total outage duration on both base stations;
a second simulation assumes the presence of two technicians onsite and calculates the sum of the outage durations for each base station (102) when each technician is assigned to recover the corresponding base stations (102); and
perform the comparison between the least total outage duration from the first calculation and the sum of outage durations from the second calculation, conducted regularly, provides justification for employing a second technician based on network outage severity.

9. The system (100) as claimed in claim 1, wherein the OSS unit (106) is configured to:
consult the planned outage and the outage prediction tools upon occurrence of the outage at time t1 for the one or more base stations (102);
determine absence of predicted outages in near term;
dispatch corresponding technicians onsite if a lack of expected outages is predicted;
delay the dispatch of the corresponding technicians until time t2 in case expected outages are predicted; and
receive the notification at time t2 indicating the prioritized base station (102) for the recovery operation.

10. The system (100) as claimed in claim 1, wherein the OSS unit (106) is configured to:
determine a decision to dispatch a drone carrying a radio node, upon the condition that the duration of travel of the drone is less than the sum of the expected duration to repair each base station (102), the estimated time of arrival of the closest technician to the corresponding base stations (102), and a specified margin, wherein the margin is adjustable within a range of 0 to a few minutes, selectable either manually by an operator managing the drone or by artificial intelligence tools based on historical data or characteristics of the corresponding base stations.

11. A method (300) for managing outages in a network, the method (300) comprising:
generating (302), by an operation support system (OSS) unit (106), an alarm signal indicating power outages of one or more base stations (102), wherein the power outages pertain to network outages, equipment failures, and any combination thereof, wherein a network management component (104) having the OSS unit (106) operatively coupled to the one or more base stations and a computing device (108);
transmitting (304) the alarm signal to the computing device (108) associated with one or more technicians located in vicinity of corresponding base stations (102);
receiving (306) notifications, from the computing device (108), indicating duration of travel by the one or more technicians to reach the base station (102) and duration of time allocated to the corresponding base stations (102) for recovery operations;
performing (308) calculations to analyze a set of attributes influencing the recovery operation of the one or more base stations (102), wherein the set of attributes pertain to the total duration of outage of corresponding base stations (102), weight of corresponding base stations, expected duration to repair each base station (102), predictions and planned outages, and any combination thereof; and
integrating (310) a decision-making process for dispatching one or more technicians, potential drone deployment, and outage period communication to associated mobile devices, while prioritizing the recovery of the one or more base stations (102) based on the calculated set of attributes to facilitate resolving the power outages.
